(19) United States
(12) Patent Application Publication
(10) Pub. No.: US 2003/0118711 A1
(43) Pub. Date: Jun. 26, 2003

(54) Flour blend for producing fried instant noodles and method for producing fried instant noodles from the flour blend

(75) Inventors: Masahiko Kamada, Chuo-ku (JP); Kenji Nakamura, Chuo-ku (JP); Hajime Akashi, Chuo-ku (JP); Takao Nagai, Chuo-ku (JP); Sadamu Ishibashi, Omiya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NISSHIN FLOUR MILLING CO., LTD., Chiyoda-ku (JP)

(21) Appl. No.: 10/309,148

(22) Filed: Dec. 4, 2002

Related U.S. Application Data
(63) Continuation of application No. 09/828,951, filed on Apr. 10, 2001, now abandoned.

(30) Foreign Application Priority Data
Apr. 12, 2000 (JP) 2000-110382

(51) Int. Cl. A23L 1/00

(52) U.S. Cl. 426/557

(57) ABSTRACT

A four blend for producing fried instant noodles and a method for producing fied instant noodles from the flour blend. The flour blend contains farina, sodium lactate, and oligosaccharide. The fried instant noodles prepared from the flour of the present invention can be cooked within a short time, have a reduced oil absorption during deep-frying, and yet maintain excellent texture and taste.

### DESCRIPTION OF THE BACKGROUND ART

1. Field of the Invention

The present invention relates to a flour blend for producing fried instant noodles and to a method for producing fried instant noodles from the flour blend. The flour blend according to the present invention is endowed with remarkable characteristics which are beneficial in the production of fried instant noodles, such as reduced oil absorption, low calorie content, and excellent texture and taste. The process according to the present invention restores the noodle to a ready-to-eat condition within only a short period of time.

2. Description of the Related Art

Instant noodles can be readily prepared and transformed into a cooked state by simply pouring hot water thereto or after cooking with heat for a short time. They also exhibit excellent storage. Due to such notable features, instant noodles have gained wide acceptance and support from consumers throughout society. According to the drying method, instant noodles are divided into the following categories: fried instant noodles (fried type), hot-air-dry noodles (non-fried type), and lyophilized noodles (freeze-dried type). Of these, fried instant noodles have currently become the mainstream of the instant noodle industry, due to their unique traits of instantaneous preparation and excellent taste, among other features.

However, because fried instant noodles absorb a large quantity of oil during the course of deep-frying, they typically have a high calorie content as compared with hot-air-dry noodles and lyophilized noodles. In recent years, from the viewpoint of prevention of pathological conditions caused by obesity or by lifestyle-related disorders, people have become keenly interested in low calorie-diets, posing a necessity for development of fried instant noodles which have absorbed smaller amounts of oil. Also, because a diversity of tastes for fried instant noodles is desired by consumers, and in particular there is need to meet the preference for a non-oily, light taste, the development of fried instant noodles which have absorbed a lesser amount of oil is needed.

In order to attain the aforementioned objects, the present inventors have carried out extensive research and have found that when, during production of fried instant noodles, sodium lactate and oligosaccharides are incorporated into noodle strands and the thus-formed noodle strands are subjected to steam treatment and then deep-frying, the amount of oil absorbed by the resultant fried instant noodles is reduced, the texture upon eating of the cooked noodles is excellent, and the fried instant noodles thus prepared can be restored to a cooked state within a time as short as that taken by conventional fried instant noodles. The present invention has been achieved on the basis of these findings.

### SUMMARY OF THE INVENTION

Accordingly, an object of the present invention is to provide a flour blend for producing fried instant noodles which can be readily and conveniently cooked within a short time, which have absorbed a reduced amount of oil as compared with conventional fried instant noodles, and which maintain excellent texture and taste. Another object of the present invention is to provide method for producing fried instant noodles from the aforementioned flour blend.

Thus, in one aspect of the present invention, there is provided a flour blend for producing fried instant noodles, which flour blend contains farina, sodium lactate, and oligosaccharide.

In another aspect of the present invention, there is provided a method for producing fried instant noodles comprising preparing noodle strands from the above-mentioned flour blend, steam-treating the resultant noodle strands, and deep-frying the steam-treated noodle strands.

Various other objects, features and many of the attendant advantages of the present invention will be readily appreciated as the same becomes better understood with reference to the following detailed description of the preferred embodiments.

### DESCRIPTION OF THE INVENTION AND THE PREFERRED EMBODIMENTS

In the production of the fried instant noodles according to the present invention, routine steps which are generally used to produce conventional fried instant noodles—i.e., steam treatment of noodle strands and subsequent deep frying in oil—are used. However, in the present invention, it is essential that the noodle strands contain sodium lactate and oligosaccharide.

The farina which is used in the present invention is not particularly limited, and any farina that has conventionally been employed in the manufacture of noodles may be used. For example, any of the following may be used: farina sources such as wheat flour, durum wheat flour, durum semolina, rye flour, barley flour, oat flour, buckwheat flour, rice flour, waxy rice flour, potato starch, tapioca starch, and corn starch; chemically modified products derived from starch sources; and gelatinized forms of these farina. These forms of farina may be used singly or in combination. Preferably, in accordance with the type of noodles to be produced, the farina is suitably selected and used in combination as needed.

In the present invention, depending on the type of fried instant noodles, in addition to the aforementioned farina, sodium lactate, and oligosaccharide, there may be used one or more of additives or auxiliary materials which have conventionally been employed. Examples of such additives include kansui (Alkaline reagent used to produce Chinese type noodles), common salt, wheat protein, egg white powder, whole egg powder, egg yolk powder, emulsifier, polysaccharides used as a thichening agent, organic acids, calcium-containing agents, skim milk, and anti-oxidation agents.

In the present invention, any form of sodium lactate may be used, so long as it is usable as a food additive. Typically, the sodium lactate is used in the form of a 50-80% aqueous solution. Preferably, the sodium lactate is first mixed with starch, then mixed with the other ingredients. In order to produce fried instant noodles exhibiting excellent characteristics—reduced amounts of absorbed oil and remarkable texture and taste—the sodium lactate is preferably added in an amount of 0.5-5 parts by weight, more preferably 1-3 parts by weight, on the basis of 100 parts by weight of farina. When the amount of sodium lactate is less than 0.5 parts by weight, the effect of reducing the amount of oil absorbed is difficult to obtain, whereas when the amount is in excess of 5 parts by weight, an effect commensurate with the extra addition cannot be obtained, making such surplus addition economically wasteful.

The oligosaccharides which are used in the present invention have a molecular structure such that two to several monosaccharides (such as disaccharide, trisaccharide, tetrasaccharide, pentasaccharide, etc.) are linked through glycoside bonding. So long as the oligosaccharide is usable as a food additive, the glycoside bonding may be of either type α or type β, and the species and number of the monosaccharides are not particularly limited. Examples of such oligosaccharides include maltose, trehalose, isomaltose, cellobiose, gentibiose, lactose, sucrose, maltotriose, raffinose, and stachyose. Of these, maltose, trehalose, lactose, and sucrose are preferred, from the viewpoints of effect to reduce oil absorption and availability. In order to produce fied instant noodles which absorb reduced amounts of oil and which exhibit excellent texture and taste, the amount of the oligosaccharide to be added to farina is preferably 0.5-8 parts by weight, more preferably 2-5 parts by weight, on the basis of 100 parts of farina. When the amount of oligosaccharide is less than 0.5 parts by weight, the effect of reducing the amount of oil absorbed is difficult to obtain, whereas when the amount is in excess of 8 parts by weight, an effect commensurate with the extra addition cannot be obtained, and in addition, the resultant noodles taste sweet, which is not desirable.

In the present invention, the method for producing noodle strands—those before being subjected to steam treatment—is not particularly limited, and there may be employed any noodle making method, such as roller noodle making, extrusion, hand made (kneading or extending with hand). Also, the mixing method, mixing conditions, method of cutting a dough sheet into noodle strands, cutting conditions, extrusion method, extrusion conditions, and the apparatus used in the respective steps are not particularly limited.

In the present invention, so long as sodium lactate and oligosaccharide are well mixed and homogeneously dispersed in noodle strands, the method of incorporating the respective ingredients into noodle strands is not particularly limited.

When the thus-prepared noodle strands that contain sodium lactate and oligosaccharide are steam-treated, the temperature of the steam is preferably 95-105° C. Any conventional steam-treatment method and apparatus may be employed. For example, while noodle strands are continuously transferred by means of, for example, a net conveyor, 95-105° C. steam is applied to the noodle strands. Alternatively, a basket or a similar container containing noodle strands is placed in a steam chamber, where 95-105° C. steam is applied thereto, to thereby perform steam treatment in a batchwise manner.

Subsequently, the steam-treated noodle strands are fied in a conventional manner. In this process, or prior to this process, the noodle strands are stirred so as not to stick to one another. An example process proceeds as follows. Noodle strands are divided into portions of one serving or several servings, then placed in molds or frames. The noodle-containing molds or frames are soaked in hot oil to remove the moisture contained in the noodles, to thereby produce fried instant noodles. The oil used in this process is a conventional one well known to those skilled in the art. Also, a conventional deep frying method and apparatus may be used. Thus, no particular limitation is imposed on the frying method and apparatus. Typically, an edible oil (such as palm oil, partially hydrogenated palm oil, purified lard, component-adjusted lard, or a mixture of these oils) is employed, and deep-frying is performed at approximately 130-160° C. for 1-3 minutes.

The type of fried instant noodles produced according to the present invention is not particularly limited. For example, Chinese-type instant noodles (which are Chinese type yellow alkaline noodles), instant udon (which is a Japanese-type white salted noodle), instant soba (which is a Japanese-type buckwheat noodle), and instant pasta may be produced.

The fried instant noodles according to the present invention may have a flavor or taste imparted to them directly thereto. Alternatively, the fried instant noodles of the present invention may be accompanied by a soup mix, seasoning, or a similar condiment, which is contained in a separate pouch.

### EXAMPLES

The present invention will next be described by way of examples, which should not be construed as limiting the invention thereto. Throughout the following description, unless otherwise specified, % refers to % by weight.

### Example 1

Ninety (90) parts by weight of a soft wheat flour (trade name “Kin-suzuran,” produced by Nisshin Flour Milling Co., Ltd.), 10 parts by weight of potato starch, 3 parts by weight of sodium lactate, and 2 parts by weight of maltose were mixed until a homogeneous mixture was attained, to thereby yield a flour blend for producing fried, Chinese-type instant noodles.

### Example 2

Eighty (80) parts by weight of a soft wheat flour (trade name “Kin-suzuran,” produced by Nisshin Flour Milling Co., Ltd.), 20 parts by weight of tapioca starch, 3 parts by weight of sodium lactate, and 4 parts by weight of maltose were mixed until a homogeneous mixture was attained, to thereby yield a flour blend for producing fried instant udon.

### Example 3

Thirty (30) parts by weight of a buckwheat flour (“Aodama” produced by Miyamoto Seifun K.K.), 55 parts by weight of a hard wheat flour (trade name: “Oshon,” produced by Nisshin Flour Milling Co., Ltd.), 15 parts by weight of potato starch, 3 parts by weight of sodium lactate, and 4 parts by weight of trehalose were mixed until a homogeneous mixture was attained, to thereby yield a flour blend for producing fried instant soba.

### Example 4

Ninety-five (95) parts by weight of a durum semolina (trade name: “Leone B” produced by Nisshin Flour Milling Co., Ltd.), 5 parts by weight of potato starch, 3 parts by weight of sodium lactate, and 4 parts by weight of maltose were mixed until a homogeneous mixture was attained, to thereby yield a flour blend for producing fried instant pasta.

### Examples 5-13 and Comparative Examples 1 and 2

(1) Wheat flour and a starch were mixed in the amounts shown in Tables 2-4, to thereby yield a starting farina mixture for producing fried Chinese-type instant noodles.

(2) To each of the resultant farina mixtures (100 parts by weight) prepared in step (1) was added an aqueous solution prepared by dissolving kansui (0.2 parts by weight), common salt (1 part by weight), and predetermined amounts of sodium lactate and oligosaccharide in water (32 parts by weight). The resultant mixture was mixed by use of a horizontal mixer for 10 minutes, yielding a corresponding dough. The thus-obtained dough was transferred to a noodle sheeting machine, sheeted between steel rollers, to thereby yield noodle dough sheets each having a thickness of 1.0 mm, from which noodle strands were cut out by passing through a pair of No. 20 round grooved cutting rolls. In Example 13, sodium lactate had been mixed with starch in advance.

(3) The noodle strands prepared from each farina blend as described in step (2) were placed in a steam basket, and 100° C. steam was applied thereto for 3 minutes to effect gelatinization. Subsequently, the noodle strands were removed from the steam basket, followed by frying in refined palm oil (temperature: 135-140° C.) for 80 seconds, to thereby yield fried instant noodles.

(4) A portion of each of the steam-treated noodles (intermediates) or fied instant noodles (final products) prepared as described in step (3) was subjected to a test which measured the percent oil-absorption of the fied instant noodles and percent reduction in oil absorption. The results are summarized in Tables 2-4.

Percent Oil Absorption of Fied Instant Noodles

According to the Soxhlet method, the oil content (%) of fried instant noodles was measured, and the persentage obtained from this measurement was used as an indicator of the oil absorption (%).

Percent Reduction in Oil Absorption

According to the Soxhlet method, the oil content (%) of fried instant noodles was measured.

Using, as a reference, the percent oil absorption of a control sample of fried instant noodles, the percent reduction in oil absorption of fried instant noodles prepared in each of the Examples and Comparative Examples, relative to the percent oil absorption of the control sample, was calculated by the following equation.

Reduction in oil absorption (%)={(A-B)/A}×100 wherein A represents the percent oil absorption of control sample (%), and B represents the percent oil absorption of each of the Examples and Comparative Examples (%)

(5) Furthermore, each of the fried, Chinese-type instant noodle samples prepared in step (3) (100 g) was cooked in 500 ml of boiling water for 3 minutes. Ten panelists ate them for sensory evaluation according to the criteria shown in Table 1. The averaged ratings are shown in Tables 2-4. In the sensory test, the ratings in relation to control samples served as the evaluation standard (a rating of 3 represents the standard). Table 1

| | |
|---|---|
| Visco- | |
| elasticity | |
| 5 | Excellent; having favorable visco-elasticity as |
| | compared with the control |
| 4 | Good; having adequate viscoelasticity as compared |
| | with the control |
| 3 | Viscoelasticity comparable to that of control |
| 2 | Somewhat inferior viscoelasticity; either softer or |
| | harder than the control |
| 1 | Poor viscoelasticity; either much softer or much |
| | harder than the control |
| Smoothness | |
| 5 | Excellent; exhibiting remarkable smoothness as |
| | compared with the control |
| 4 | Good; exhibiting improved smoothness as compared with |
| | the control |
| 3 | Smoothness comparable to that of the control |
| 2 | Poor; Smoothness notably inferior to that of the |
| | control |
| 1 | Very poor; Smoothness considerably inferior to that |
| | of the control |
| Oil odor, | |
| oiliness | |
| and taste | |
| 5 | Good taste; greatly reduced oily odor/oiliness as |
| | compared with the control |
| 4 | Fairly good taste; somewhat reduced oily |
| | oder/oiliness as compared with the control |
| 3 | Oil smell/greasiness comparable to that of the |
| | control |
| 2 | Slightly inferior taste; oily odor/oiliness somewhat |
| | conspicuous as compared with the control |
| 1 | Very poor taste; oily odor/oiliness considerably |
| | conspicuous as compared with the control |

TABLE 2

| | | | | | Comp. |
|---|---|---|---|---|---|
| | Control | Ex. 5 | Ex. 6 | Ex. 7 | Ex. 1 |
| Medium wheat flour | 90 | 90 | 90 | 90 | 90 |
| (parts by weight) | | | | | |
| Potato starch | 10 | 10 | 10 | 10 | 10 |
| (parts by weight) | | | | | |
| Sodium lactate | — | 3 | 3 | 3 | 3 |
| (parts by weight) | | | | | |
| Maltose | — | 1 | 5 | 7 | — |
| (parts by weight) | | | | | |
| Kansui | 0.2 | 0.2 | 0.2 | 0.2 | 0.2 |
| (parts by weight) | | | | | |
| Common salt | 1.0 | 1.0 | 1.0 | 1.0 | 1.0 |
| (parts by weight) | | | | | |
| Water | 32 | 32 | 32 | 32 | 32 |
| (parts by weight) | | | | | |
| Oil absorption (%) | 21.6 | 16.5 | 14.1 | 16.2 | 20.0 |
| Reduction in oil absorption | 0 | 23.8 | 34.7 | 25.2 | 8.9 |
| with respect to control (%) | | | | | |
| Viscoelasticity | 3.0 | 4.1 | 4.2 | 3.5 | 3.0 |
| Smoothness | 3.0 | 3.3 | 3.5 | 3.0 | 3.0 |
| Oily odor/oiliness | 3.0 | 4.1 | 4.4 | 4.1 | 3.4 |

As is apparent from Table 2, noodle samples of Examples 5-7, which are prepared by use of noodle strands containing both sodium lactate and maltose, exhibit notably smaller oily odor/oiliness as compared with the control sample or the samples from Comparative Example 1. Particularly, noodles of Example 6 demonstrate a remarkable effect of the present invention to reduce oil absorption.

TABLE 3

| | Ex. 8 | Ex. 9 | Comp. Ex. 2 |
|---|---|---|---|
| Medium wheat flour | 90 | 90 | 90 |
| (parts by weight) | | | |
| Potato starch | 10 | 10 | 10 |
| (parts by weight) | | | |
| Sodium lactate | 0.5 | 5 | — |
| (parts by weight) | | | |
| Maltose | 5 | 5 | 5 |
| (parts by weight) | | | |
| Kansui | 0.2 | 0.2 | 0.2 |
| (parts by weight) | | | |
| Common salt | 1.0 | 1.0 | 1.0 |
| (parts by weight) | | | |
| Water | 32 | 32 | 32 |
| (parts by weight) | | | |
| Oil absorption (%) | 16.5 | 16.4 | 19.6 |
| Reduction in oil absorption | 23.8 | 24.2 | 9.4 |
| with respect to control (%) | | | |
| Resistance to mastication | 4.0 | 3.5 | 3.0 |
| Smoothness | 3.3 | 3.0 | 3.2 |
| Oily odor/oiliness | 4.0 | 4.1 | 3.4 |

As is apparent from Table 3, noodle samples of Examples 8 and 9 exhibit notably smaller oily odor/oiliness as compared with the control sample.

TABLE 4

| | Ex. 10 | Ex. 11 | Ex. 12 | Ex. 13 |
|---|---|---|---|---|
| Medium wheat flour | 90 | 90 | 90 | 90 |
| (parts by weight) | | | | |
| Potato starch | 10 | 10 | 10 | 10 |
| (parts by weight) | | | | |
| Sodium lactate | 3 | 3 | 3 | 3 |
| (parts by weight) | | | | |
| Maltose | — | — | — | — |
| (parts by weight) | | | | |
| Trehalose | 4 | — | — | 4 |
| (parts by weight) | | | | |
| Lactose | — | 4 | — | — |
| (parts by weight) | | | | |
| Sucrose | — | — | 4 | — |
| (parts by weight) | | | | |
| Dextrin | — | — | — | — |
| (parts by weight) | | | | |
| Kansui | 0.2 | 0.2 | 0.2 | 0.2 |
| (parts by weight) | | | | |
| Common salt | 1.0 | 1.0 | 1.0 | 1.0 |
| (parts by weight) | | | | |
| Water | 32 | 32 | 32 | 32 |
| (parts by weight) | | | | |
| Oil absorption (%) | 14.5 | 14.5 | 14.6 | 14.9 |
| Reduction in oil absorption | 33.0 | 33.0 | 32.5 | 31.0 |
| with respect to control (%) | | | | |
| Resistance to mastication | 4.2 | 4.0 | 4.0 | 4.0 |
| Smoothness | 3.6 | 3.1 | 3.2 | 3.6 |
| Oily odor/oiliness | 4.4 | 4.4 | 4.4 | 4.3 |

As is apparent from Table 4, noodle samples of Examples 10-13 exhibit a notable effect to reduce oil absorption as compared with the case of the control sample.

Obviously, numerous modifications and variations of the present invention are possible in light of the above teachings and descriptions. It is therefore to be understood that within the scope of the appended claims, the present invention may be practiced in manners other than as specifically described herein.

What is claimed is:

1. A four blend for producing fried instant noodles, which comprises farina, sodium lactate, and oligosaccharide.

2. A four blend as claimed in claim 1, wherein the proportions of the farina, sodium lactate, and oligosaccharide are 100 parts by weight, 0.5-5 parts by weight, and 0.5-8 parts by weight, respectively.

3. A method for producing fried instant noodles comprising preparing noodle strands from a flour blend as claimed in claim 1, steam-treating the resultant noodle strands, and deep-frying the steam-treated noodle strands.

4. A method for producing fried instant noodles comprising preparing noodle strands from a flour blend as claimed in claim 2, steam-treating the resultant noodle strands, and deep-frying the steam-treated noodle strands.
